(19) United States
(12) Patent Application Publication
(10) Pub. No.: US 2021/0179826 A1
(43) Pub. Date: Jun. 17, 2021

(54) RUBBER COMPOSITION FOR INNER LINER AND PNEUMATIC TIRE USING THE SAME

(71) Applicant: Toyo Tire Corporation, Itami-shi (JP)

(72) Inventor: Masaki Kanaya, Itami-shi (JP)

(73) Assignee: Toyo Tire Corporation, Itami-shi (JP)

(21) Appl. No.: 17/117,662

(22) Filed: Dec. 10, 2020

(30) Foreign Application Priority Data
Dec. 13, 2019 (JP) 2019-225585

(51) Int. Cl. C08L 15/02; B60C 1/00

(52) U.S. Cl. CPC C08L 15/02; B60C 1/0008

(57) ABSTRACT

Provided are a rubber composition for an inner liner having excellent air permeability resistance and low temperature fatigue resistance, and a pneumatic tire using the same. The rubber composition for an inner liner contains 1 to 20 parts by mass of a polybutadiene which contains 30 mol % or less of 1,2-vinyl group and which is liquid at room temperature, with respect to 100 parts by mass of a rubber component which is solid at room temperature.

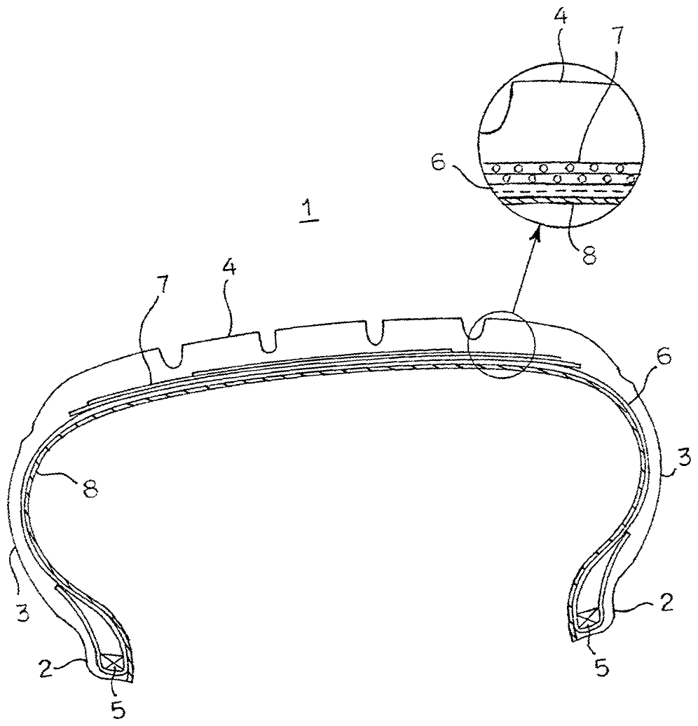

### BACKGROUND OF THE INVENTION

### 1. Field of the Invention

The present disclosure relates to a rubber composition for an inner liner and a pneumatic tire using the same.

### 2. Description of Related Art

An inner liner is provided on an inner surface of a pneumatic tire as an air permeation preventing layer in order to keep the tire air pressure constant. The inner liner is generally formed of a layer of rubber such as butyl rubber or butyl halogenated rubber with low air permeability.

For example, JP-A-2014-37198 describes a pneumatic tire using a rubber composition containing liquid polyisoprene as a pneumatic tire provided with an inner liner.

JP-A-2019-38903 describes a thermoplastic elastomer composition containing liquid polybutadiene as a thermoplastic elastomer composition that improves low temperature durability while preventing a decrease in gas barrier property, and describes at paragraph 0025 of the description that the content of 1,2-binding component is preferably 85 mol % or more as liquid polybutadiene.

Japanese Patent No. 5032771 describes a pneumatic tire having an inner liner formed of a rubber composition including liquid diene rubber, and in the embodiment thereof, liquid polyisoprene rubber is used as the liquid diene rubber.

However, rubber compositions for an inner liner of the related arts have room for improvement in air permeability resistance and low temperature fatigue resistance.

### SUMMARY OF THE INVENTION

In view of the above points, an object of the present disclosure is to provide a rubber composition for an inner liner having excellent air permeability resistance and low temperature fatigue resistance, and a pneumatic tire using the same.

The rubber composition for an inner liner according to the present disclosure contains 1 to 20 parts by mass of polybutadiene which contains 30 mol % or less of 1,2-vinyl group and which is liquid at room temperature (hereafter, also referred to as “liquid polybutadiene”), with respect to 100 parts by mass of a rubber component which is solid at room temperature (hereinafter, also referred to as “solid rubber component”). The “solid rubber component” refers to a rubber which is solid at room temperature of 23° C., and the “solid” means a state having no fluidity. The “liquid polybutadiene” refers to a polybutadiene which is liquid at a room temperature of 23° C., and the “liquid” refers to a state having fluidity.

In the rubber composition for an inner liner according to the present disclosure, the content ratios in 100 parts by mass of the solid rubber component can be 30 to 100% by mass of butyl rubber and 0 to 70% by mass of diene rubber.

The number average molecular weight of liquid polybutadiene can be between 5000 and 50000.

The pneumatic tire according to the present disclosure includes an inner liner formed of the rubber composition for an inner liner described above.

According to the rubber composition for an inner liner of the present disclosure, it is possible to provide a pneumatic tire having excellent air permeability resistance and low temperature fatigue resistance.

### BRIEF DESCRIPTION OF THE DRAWINGS

The FIGURE is a cross-sectional view showing a pneumatic tire according to an embodiment of the present disclosure.

### DETAILED DESCRIPTION OF INVENTION

Hereinafter, matters related to the embodiments of the present disclosure will be described in detail.

The rubber composition for an inner liner according to the present embodiment contains 1 to 20 parts by mass of a polybutadiene which contains 30 mol % or less of 1,2-vinyl group and which is liquid at room temperature, with respect to 100 parts by mass of a rubber component which is solid at room temperature.

In the rubber composition for a tire according to the present embodiment, the solid rubber component is not particularly limited, but examples thereof include butyl rubber and diene rubber, and preferably the butyl rubber alone or a combination of butyl rubber and diene rubber.

Examples of the butyl rubber according to the present embodiment include a butyl halogenated rubber (for example, a brominated butyl rubber (BIIR), a chlorinated butyl rubber (CIIR), and the like), and a butyl rubber (IIR).

Examples of the diene rubber according to the present embodiment include a natural rubber (NR), an isoprene rubber (IR), a butadiene rubber (BR), a styrene-butadiene rubber (SBR), a nitrile rubber (NBR), a chloroprene rubber (CR), and a styrene-isoprene rubber, a butadiene-isoprene rubber, a styrene-butadiene-isoprene rubber, and the like.

The rubber component according to the present embodiment preferably contains butyl rubber and diene rubber at a ratio of 30 to 100% by mass of butyl rubber and 0 to 70% by mass of diene rubber, more preferably, at a ratio of 50 to 100% by mass of butyl rubber and 0 to 50% by mass of diene rubber, and still more preferably, at a ratio of 80 to 100% by mass of butyl rubber and 0 to 20% by mass of diene rubber.

The liquid polybutadiene contains 30 mol % or less, and preferably 20 mol % or less of 1,2-vinyl group. Here, the content of 1,2-vinyl group is the content of 1,2-vinyl group with respect to the content of butadiene unit contained in the liquid polybutadiene, and can be measured by using a nuclear magnetic resonance apparatus (NMR).

The glass transition temperature (Tg) of the liquid polybutadiene is not particularly limited, but is preferably −80° C. or lower, and more preferably −90 to −100° C. Here, the glass transition temperature is a value measured at a heating rate of 20° C./min (measurement temperature range: −150° C. to 50° C.) by the differential scanning calorimetry (DSC) method in accordance with JIS K7121.

The number average molecular weight of the liquid polybutadiene is not particularly limited, but is preferably 5000 to 50000, and more preferably 8000 to 30000. Here, the number average molecular weight (Mn) is a value obtained by measuring with the gel permeation chromatography (GPC) and calculating in terms of polystyrene.

For such liquid polybutadiene, commercially available products can be used, and examples thereof include “LBR-302”, “LBR-305”, and “LBR-307” manufactured by Kuraray Co., Ltd.

The content of liquid polybutadiene is not particularly limited, but is preferably 1 to 20 parts by mass, more preferably 1 to 10 parts by mass, and still more preferably 1 to 5 parts by mass with respect to 100 parts by mass of the solid rubber component.

The rubber composition according to the present embodiment contains 30 mol % or less of 1,2-vinyl group, and can contain liquid polybutadiene to improve air permeability resistance and low temperature fatigue resistance. The precise mechanism is not clear, but can be inferred as follows. That is, when the 1,2-vinyl group content is 30 mol % or less, in a low temperature environment, flexibility is imparted and low temperature fatigue resistance is improved. Since the liquid polybutadiene has a larger molecular weight and is more viscous than oil, it can be inferred that the viscous flow of rubber composition is prevented and the diffusion of gas molecules is prevented, so that the air permeability resistance is improved.

The rubber composition according to the present embodiment may contain oil, and then, the content thereof is preferably 5 parts by mass or less with respect to 100 parts by mass of the rubber component, and is preferably not substantially contained (specifically, less than 1 part by mass) from the viewpoint of gas permeability resistance.

The content ratio of oil and liquid polybutadiene (oil:liquid polybutadiene) is not particularly limited, but is preferably 0:10 to 9:1, and more preferably 3:7 to 6:4.

The rubber composition according to the present embodiment can include a pulverized bituminous coal obtained by finely crushing bituminous coal. The pulverized bituminous coal can improve air permeability resistance. The average particle size of the pulverized bituminous coal is preferably 0.5 to 100 and more preferably 1 to 30 The average particle size can be measured by the laser diffraction/scattering method.

The pulverized bituminous coal having an aspect ratio of 5 to 30 can be used, for example. The aspect ratio is a ratio to the thickness of a long diameter (maximum dimension in the flat surface portion). The aspect ratio can be determined with the transmission electron microscope (TEM). Specifically, in a TEM image, the long diameter and the thickness of 10 randomly selected particles are measured to calculate the aspect ratio of each particle. The “aspect ratio of the pulverized bituminous coal” is the arithmetic mean of the aspect ratios.

The amount of the pulverized bituminous coal is preferably 5 to 50 parts by mass or more, more preferably 5 to 40 parts by mass, and still more preferably 5 to 30 parts by mass with respect to 100 parts by mass of the rubber component.

The rubber composition according to the present embodiment may contain carbon black as a filler. The iodine adsorption (IA) amount by carbon black can be 15 mg/g to 55 mg/g, for example. The iodine adsorption amount is a value measured in accordance with JIS K6217-1. The absorption amount of dibutyl phthalate (DBP) oil by carbon black can be, for example, 75 cm³/100 g to 125 cm³/100 g. The DBP oil absorption amount is a value measured in accordance with JIS K6217-4. Specifically, GPF grade carbon black is preferable.

The content of carbon black is preferably 30 to 70 parts by mass, and more preferably 40 to 60 parts by mass with respect to 100 parts by mass of rubber component in the rubber composition.

The total amount of carbon black and the pulverized bituminous coal is preferably 35 to 120 parts by mass, more preferably 40 to 110 parts by mass, and still more preferably 50 to 100 parts by mass with respect to 100 parts by mass of the rubber component in the rubber composition.

Zinc oxide may be added to the rubber composition according to the present embodiment. The zinc oxide is added as a vulcanizing agent (crosslinking agent) for butyl halogenated rubber, and added in an amount of preferably 0.5 to 10 parts by mass, and more preferably 1 to 5 parts by mass with respect to 100 parts by mass of the rubber component.

A tackifying agent may be added to the rubber composition according to the present embodiment. The tackifying agent is an additive that imparts stickiness to unvulcanized rubber composition, and is also referred to as a tackifier. The tackifying agent is preferably hydrocarbon resin such as aliphatic petroleum resin, aromatic petroleum resin, and aliphatic/aromatic copolymer petroleum resin, and more preferably, C5-based petroleum resin obtained by cationically polymerizing an unsaturated monomer such as isoprene or cyclopentadiene which is a petroleum fraction equivalent to 4 to 5 carbon atoms. The amount of the tackifying agent is not particularly limited, but is preferably 1 to 15 parts by mass, and more preferably 2 to 10 parts by mass with respect to 100 parts by mass of the rubber component.

The method for producing the rubber composition according to the present embodiment is not particularly limited, and can be produced by kneading with a commonly used mixing machine, such as a Banbury mixer, a kneader, or a roll, according to a method of the related arts. For example, a rubber composition can be prepared by adding other additives excluding a vulcanizing agent and a vulcanization accelerator to the diene rubber followed by kneading in a first mixing stage (non-processing kneading process), and then adding a vulcanizing agent and a vulcanization accelerator to the resultant mixture followed by kneading in a final mixing step (processing kneading process).

In addition to the components described above, various additives usually added in the rubber composition for an inner liner, such as an age resister, a processing aid, sulfur, and a vulcanization accelerator, can be added in the rubber composition according to the present embodiment. Examples of sulfur include powdered sulfur, precipitated sulfur, colloidal sulfur, insoluble sulfur, and highly dispersible sulfur, and is preferably added in an amount of 3 parts by mass or less (may not be added), and more preferably 2 parts by mass or less with respect to 100 parts by mass of the rubber component.

The rubber composition for an inner liner according to the present embodiment can be applied to various pneumatic tires such as tires for various automobiles including tires for passenger cars, heavy-duty tires for trucks, buses and the like, and tires for two-wheeled vehicles including bicycles.

The FIGURE is a cross-sectional view showing a pneumatic tire 1 according to an embodiment. As shown, the pneumatic tire 1 includes a pair of bead portions 2 to be rim-assembled, a pair of sidewall portions 3 extending outward in the radial direction of the tire from the bead portions 2, and a tread portion 4 provided between the pair of sidewall portions 3 and grounded on the road surface. A ring-shaped bead core 5 is embedded in each of the pair of bead portions 2. A carcass ply 6 using an organic fiber cord is folded around the bead core 5 and locked, and is provided to be bridged between the left and right bead portions 2. On an outer peripheral side of the tread portion 4 of the carcass ply 6, a belt 7 formed of two belt plies using a rigid tire cord such as a steel cord or an aramid fiber is provided.

Inside the carcass ply 6, an inner liner 8 is provided over the entire inner surface of the tire. In the present embodiment, the rubber composition for an inner liner is used as the inner liner 8. The inner liner 8 is attached to the inner surface of the carcass ply 6, which is the rubber layer on the inner surface side of the tire, as shown in the enlarged view in the FIGURE, and more specifically, is attached to the inner surface of a topping rubber layer covering the cord of the carcass ply 6.

A method for manufacturing a pneumatic tire according to the present embodiment includes, for example, with the rubber composition for an inner liner as an inner liner, mounting the inner liner in a tubular shape on an outer circumference of a molding drum, attaching a carcass ply thereon, further assembling and inflating each tire member such as a belt, tread rubber and sidewall rubber to produce a green tire (unvulcanized tire), and vulcanizing and molding the green tire in a mold to produce a pneumatic tire. In the example shown in the FIGURE, although the rubber composition for an inner liner is provided on the inner surface side of the carcass ply, as long as the tire pressure can be maintained by preventing the permeation of air from the inside of the tire, that is, as long as the rubber composition for an inner liner is provided as an air permeation preventing layer for maintaining the internal pressure, the rubber composition for an inner liner can be provided at various positions such as on the outer surface side of the carcass ply, and there is no particular limitation thereto.

### Examples

Hereinafter, certain examples of the present disclosure are described below, but the present disclosure is not construed as being limited to the examples.

By using a Banbury mixer, the components excluding the vulcanization accelerator were first added and mixed in the non-processing kneading step (discharge temperature=150° C.) according to the formulation (parts by mass) shown in Table 1 below, and in the processing kneading step, the vulcanization accelerator was added and mixed (discharge temperature=90° C.) to prepare a rubber composition for an inner liner. The details of each components in Table 1 are as follows.
Brominated butyl rubber: “Bromobutyl 2222” manufactured by JAPAN BUTYL Co., Ltd.
Carbon black: “SEAST V” manufactured by Tokai Carbon Co., Ltd.
Pulverized bituminous coal: “Austin Black 325” manufactured by Coal Fillers, Inc.
Tackifying agent: “T-REZ RA100” manufactured by Tonen Chemical Corp.
Oil: “PROCESS NC-140” manufactured by JXTG Nippon Oil & Energy Corp., viscosity=0.03 Pa·s
Liquid rubber A: “LBR-305” manufactured by Kuraray Co., Ltd., polybutadiene, number average molecular weight=8000, Tg=−95° C., 1,2-vinyl group content=9 mol %, viscosity=1.5 Pa·s
Liquid rubber B: “LBR-307” manufactured by Kuraray Co., Ltd., polybutadiene, number average molecular weight=26000, Tg=−95° C., 1,2-vinyl group content=15 mol %, viscosity=40 Pa·s
Liquid rubber C: “LIR-30” manufactured by Kuraray Co., Ltd., polyisoprene, number average molecular weight=28000, Tg=−63° C., 1,2-vinyl group content=0 mol %, viscosity=70 Pa·s
Liquid rubber D: “B-3000” manufactured by Nippon Soda Co., Ltd., polybutadiene, number average molecular weight=3200, Tg=−15° C., 1,2-vinyl group content=90 mol %, viscosity=21 Pa·s
Zinc oxide: “Zinc Oxide 3 Species” manufactured by Mitsui Mining & Smelting Co., Ltd.
Stearic acid: “LUNAC S-20” manufactured by Kao Corporation
Vulcanization accelerator: “NOCCELER-DM-P” manufactured by Ouchi Shinko Chemical Industrial Co., Ltd.

The methods for measuring the viscosity, number average molecular weight, glass transition temperature, and 1,2-vinyl group content ratio (mol %) of liquid rubber are as follows.
Viscosity: Measured using a Brookfield type viscometer at 38° C. in accordance with JIS K7117-1.
Number average molecular weight: Measured with gel permeation chromatography (GPC) and calculated in terms of polystyrene. Specifically, for the measurement sample, 0.2 mg of each sample dissolved in 1 mL of THF was used. By using “LC-20DA” manufactured by Shimadzu Corporation, the measurement sample was passed through a filter and then passed through columns (“PL Gel 3 μm Guard×2” manufactured by Polymer Laboratories) at a temperature of 40° C. and a flow rate of 0.7 mL/min, and detected by “RI Detector” manufactured by Spectra System.
Glass transition temperature: Measured at a heating rate of 20° C./min (measurement temperature range: −150° C. to 50° C.) by the differential scanning calorimetry (DSC) method in accordance with JIS K7121.
1,2-vinyl group content ratio (mol %): The structure was identified by NMR, and the content of 1,2-vinyl group in liquid rubber was calculated from the resultant NMR spectrum. The NMR spectrum is a value calculated by the integration ratio of the ¹H NMR spectrum.

The resultant rubber composition was evaluated for air permeability resistance and low temperature fatigue resistance. Each evaluation method is as follows.
Air permeability resistance: For a vulcanized rubber sheet with a thickness of 1 mm that was vulcanized at 160° C. for 30 minutes, the air permeability was measured using a gas permeability tester (“BT-3” manufactured by Toyo Seiki Seisaku-sho, Ltd.), and an index was represented relative to the value of Comparative Example 1 as 100. It is demonstrated that as the numerical value is larger, the air permeability resistance is better.
Low temperature fatigue resistance: In accordance with JIS K6260, the number of times of flexing of a test sample vulcanized at 160° C. for 30 minutes was measured at −35° C. until the crack length reached 10 mm with a De Mattia flex test device. An index was represented relative to the number of flexing in Comparative Example 1 as 100, and it is demonstrated that, as the numerical value is smaller, the low temperature flexural fatigue resistance is better. The length of the naturally occurring crack was added to the crack length.

TABLE 1

| | Com. | Com. | Com. | Com. | Com. | | | | | | |
|---|---|---|---|---|---|---|---|---|---|---|---|
| | 1 | 2 | 3 | 4 | 5 | Ex.1 | Ex.2 | Ex.3 | Ex.4 | Ex.5 | Ex.6 |
| Brominated | 100 | 100 | 100 | 100 | 100 | 100 | 100 | 100 | 100 | 100 | 100 |
| butyl rubber | | | | | | | | | | | |
| Carbon black | 50 | 50 | 50 | 50 | 50 | 50 | 50 | 50 | 50 | 50 | 50 |
| Pulverized | 10 | 10 | 10 | 10 | 10 | 10 | 10 | 10 | 10 | 10 | 10 |
| bituminous coal | | | | | | | | | | | |
| Tackifying agent | 3 | 3 | 3 | 3 | 3 | 3 | 3 | 3 | 3 | 3 | 3 |
| Oil | 5 | 10 | — | — | — | — | — | — | — | — | 2 |
| Liquid rubber A | — | — | — | 30 | — | 1 | 5 | 10 | 20 | — | 3 |
| Liquid rubber B | — | — | — | — | — | — | — | — | — | 5 | — |
| Liquid rubber C | — | — | 5 | — | — | — | — | — | — | — | — |
| Liquid nibber D | — | — | — | — | 5 | — | — | — | — | — | — |
| Zinc oxide | 3 | 3 | 3 | 3 | 3 | 3 | 3 | 3 | 3 | 3 | 3 |
| Stearic acid | 1 | 1 | 1 | 1 | 1 | 1 | 1 | 1 | 1 | 1 | 1 |
| Vulcanization | 2 | 2 | 2 | 2 | 2 | 2 | 2 | 2 | 2 | 2 | 2 |
| accelerator | | | | | | | | | | | |
| 1,2-vinyl group | — | — | 0 | 9 | 90 | 9 | 9 | 9 | 9 | 15 | 9 |
| content (mol %) | | | | | | | | | | | |
| Air permeability | 100 | 75 | 108 | 97 | 150 | 130 | 115 | 108 | 101 | 118 | 107 |
| resistance | | | | | | | | | | | |
| Low temperature | 100 | 90 | 220 | 20 | 200 | 80 | 45 | 30 | 20 | 15 | 60 |
| fatigue resistance | | | | | | | | | | | |

The results are as shown in Table 1, and from the comparison between Examples 1 to 6 and Comparative Example 1, it can be seen that when the polybutadiene which contains 30 mol % or less of 1,2-vinyl group and which is liquid at room temperature is contained, the air permeability resistance and low temperature fatigue resistance were improved.

From the comparison between Comparative Examples 1 and 2, it can be seen that the air permeability resistance was deteriorated when the amount of oil was increased.

From the comparison between Comparative Examples 1 and 3, it can be seen that the low temperature fatigue resistance was deteriorated when liquid isoprene rubber was contained.

From the comparison between Comparative Examples 1 and 4, it can be seen that the air permeability resistance was deteriorated when the liquid polybutadiene was contained in an amount of more than 20 parts by mass.

From the comparison between Comparative Examples 1 and 5, it can be seen that the low temperature fatigue resistance was deteriorated when the liquid polybutadiene containing more than 30 mol % of 1,2-vinyl group was contained.

The rubber composition for an inner liner according to the present disclosure can be used for the inner liners of various tires of passenger cars, light duty trucks and buses, and the like.

What is claimed is:

1. A rubber composition for an inner liner containing 1 to 20 parts by mass of a polybutadiene which contains 30 mol % or less of 1,2-vinyl group and which is liquid at room temperature, with respect to 100 parts by mass of a rubber component which is solid at room temperature.

2. The rubber composition for an inner liner according to claim 1, wherein, in 100 parts by mass of the rubber component which is solid at room temperature, a content ratio is 30 to 100% by mass for a butyl rubber and 0 to 70% by mass for a diene rubber.

3. The rubber composition for an inner liner according to claim 1, wherein a number average molecular weight of the polybutadiene which is liquid at room temperature is 5000 to 50000.

4. The rubber composition for an inner liner according to claim 2, wherein a number average molecular weight of the polybutadiene which is liquid at room temperature is 5000 to 50000.

5. A pneumatic tire comprising an inner liner containing the rubber composition for an inner liner according to claim 1.

6. A pneumatic tire comprising an inner liner containing the rubber composition for an inner liner according to claim 2.

7. A pneumatic tire comprising an inner liner containing the rubber composition for an inner liner according to claim 3.
